(19) United States
(12) Patent Application Publication
(10) Pub. No.: US 2026/0104113 A1
(43) Pub. Date: Apr. 16, 2026

(54) EXPANDABLE HOSE

(71) Applicant: Winston Products LLC, Cleveland, OH (US)

(72) Inventor: Jesse Paradis, North Royalton, OH (US)

(21) Appl. No.: 19/356,624

(22) Filed: Oct. 13, 2025

Related U.S. Application Data
(60) Provisional application No. 63/706,076, filed on Oct. 11, 2024.

(51) Int. Cl. F16L 11/12

(52) U.S. Cl. CPC F16L 11/122

(57) ABSTRACT

A hose includes a first connector assembly, a second connector assembly, and a hose assembly coupled to the first and second connector assemblies. The hose assembly includes outer and inner hose members, each having first and second ends. A first hose connector assembly includes a first tube connector having an elongate portion. An inner surface of the inner hose member at the first end thereof contacts an outer surface of the elongate portion, and an inner surface of the outer hose member at the first end thereof contacts an outer surface of the inner hose member at the first end thereof.

### CROSS-REFERENCE TO RELATED APPLICATIONS

This application claims the benefit of U.S. Provisional Patent Application No. 63/706,076, filed October 11, 2024, which is incorporated herein by reference.

### FIELD OF THE INVENTION

The present invention relates generally to a hose, and more particularly to a hose for use with a spigot. The hose includes a first end that can be connected to a spigot, and a second end that can receive a nozzle, sprinkler, or other suitable device.

### BACKGROUND

Hoses can be provided for attachment to a spigot at a home, for example, for watering lawns and gardens. The hoses can be rolled up on a hose reel when not in use or may be expandable hoses that retract when the water is turned off.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein can be utilized to provide a hose having a first connector assembly including a regulator assembly configured to regulate a flow of fluid through the hose to reduce a pressure of the fluid. The hose further includes a second connector assembly and a hose assembly coupled to the first and second connector assemblies. The hose assembly includes an outer hose member having first and second ends, and an inner hose member having first and second ends, wherein the inner hose member is disposed within the outer hose member. The hose assembly further includes a first hose connector assembly coupled to the first ends of the inner hose member and the outer hose member, and the first connector assembly. The first hose connector assembly includes a first tube connector having a base disposed in a body of the regulator assembly and an elongate portion extending from the base. An inner surface of the inner hose member at the first end thereof contacts an outer surface of the elongate portion, and an inner surface of the outer hose member at the first end thereof contacts an outer surface of the inner hose member at the first end thereof.

In yet a further embodiment, a hose includes a first connector assembly having a regulator assembly configured to regulate a flow of fluid through the hose to reduce a pressure of the fluid. The hose further includes a second connector assembly and a hose assembly coupled to the first and second connector assemblies. The hose assembly includes an outer hose member having first and second ends, wherein the outer hose member is exposed to an ambient environment, an inner hose member having first and second ends, wherein the inner hose member is disposed within the outer hose member, and a first hose connector assembly coupled to the first ends of the inner hose member and the outer hose member, and the first connector assembly.

The first hose connector assembly includes a first tube connector and a first retainer, wherein the first tube connector has a base disposed in a body of the regulator assembly and an elongate portion extending from the base, and wherein the first retainer surrounds the elongate portion. Further, an inner surface of the inner hose member at the first end thereof contacts an outer surface of the elongate portion, wherein an inner surface of the outer hose member at the first end thereof contacts an outer surface of the inner hose member at the first end thereof, and wherein an inner surface of the first retainer contacts an outer surface of the outer hose member at the first end thereof. Further still, the hose does not longitudinally expand when subjected to the fluid.

To the accomplishment of the foregoing and related ends, the following description and drawings set forth certain illustrative aspects and implementations. These are indicative of but a few of the various ways in which one or more aspects may be employed. Other aspects, advantages and novel features of the disclosure will become apparent from the following detailed description when considered in conjunction with the drawings.

### BRIEF DESCRIPTION OF THE DRAWINGS

FIG. 1 is a perspective view of one example of an expandable hose;

FIG. 2 is a side view of select elements of the hose depicted in FIG. 1;

FIG. 3 is a perspective view of a first connector assembly of the hose;

FIG. 4 is a cross-sectional view of the first connector assembly;

FIG. 5 is a perspective view of a second connector assembly of the hose;

FIG. 6 is a cross-sectional view of the second connector assembly;

FIG. 7 is a partially exploded view of another embodiment of a second connector assembly configured to matingly engage with one of a plurality of male fittings of a quick connector;

FIG. 8 is a cross-sectional view of the second connector assembly shown in FIG. 7, in an unconnected state; and

FIG. 9 is a cross-sectional view of the second connector assembly shown in FIG. 7, in a connected state with one of the male fittings.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

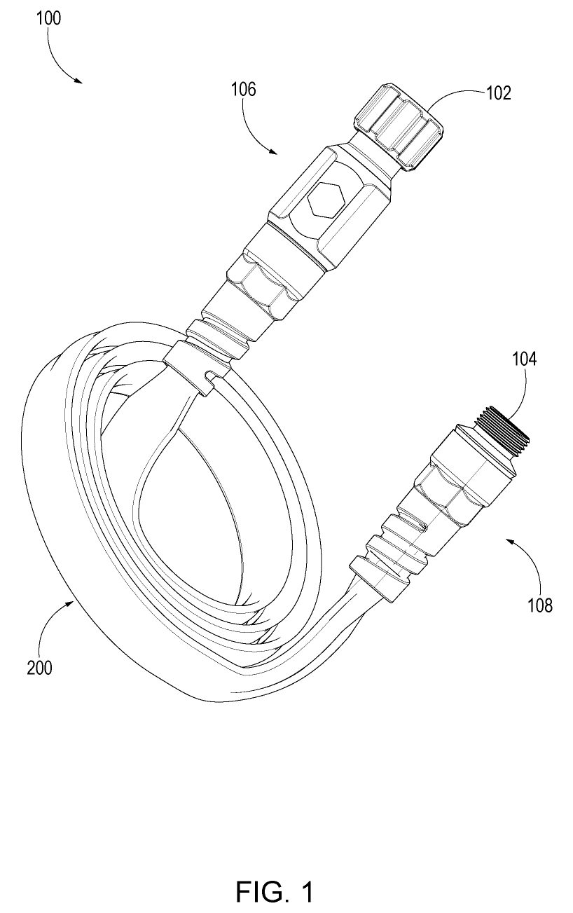

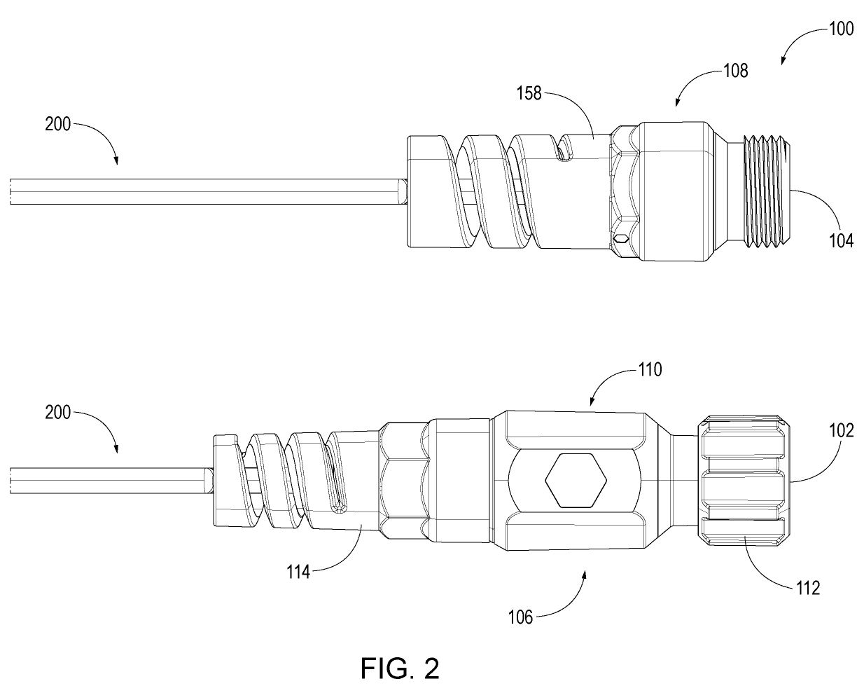

Turning now to FIGS. 1-2, an expandable hose 100 is shown. As will be discussed further below, various elements of the expandable hose 100 can be automatically expanded radially (i.e., laterally) upon the introduction of fluid pressure and automatically contracted (again laterally) when there is no fluid pressure. The expandable hose 100 has opposite, first and second ends 102, 104, and a hose assembly 200 extending therebetween. As further shown, a first connector assembly 106 is provided at the first end 102 and a second connector assembly 108 is provided at the second end 104 such that corresponding ends of the hose assembly 200 are connected to the first and second connector assemblies 106, 108, respectively. In operation, the first connector assembly 106 is configured to couple to a spigot and the second connector assembly 108 is configured to couple to a water delivery device (e.g., a nozzle, spray wand, sprinkler, water toy, etc.) or even to a vehicle or other powered component. Notably, the first connector assembly 106 may be configured to couple directly to a spigot (i.e., without any intervening member therebetween). Alternatively, as will be described further below, the first connector assembly 106 may be fluidly coupled to the spigot via an intermediate member, such as via a male-to-female quick connector. Similarly, the second connector assembly 108 may be configured to couple directly to the water delivery device, vehicle, powered component, etc., or may be fluidly coupled thereto via an intermediate member (e.g., a male-to-female quick connector), as described below.

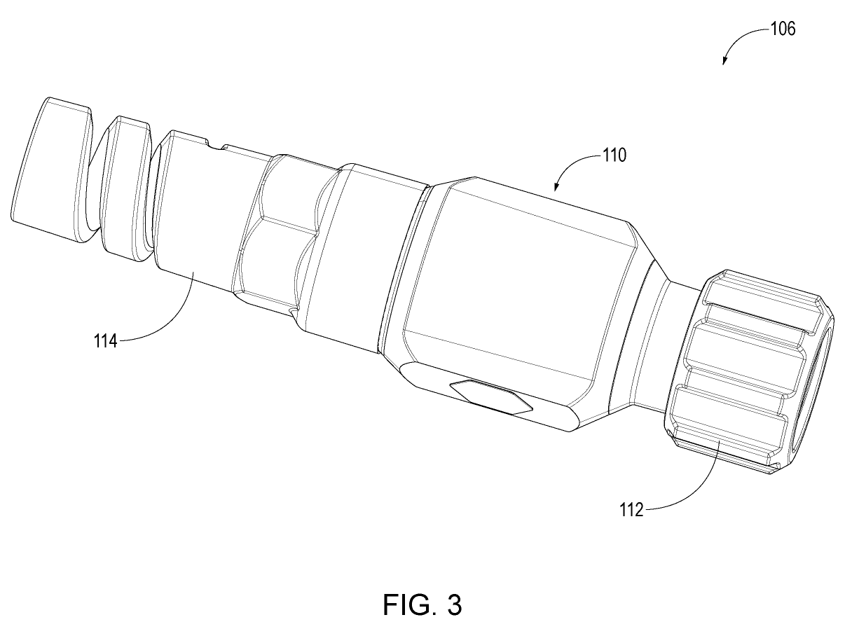

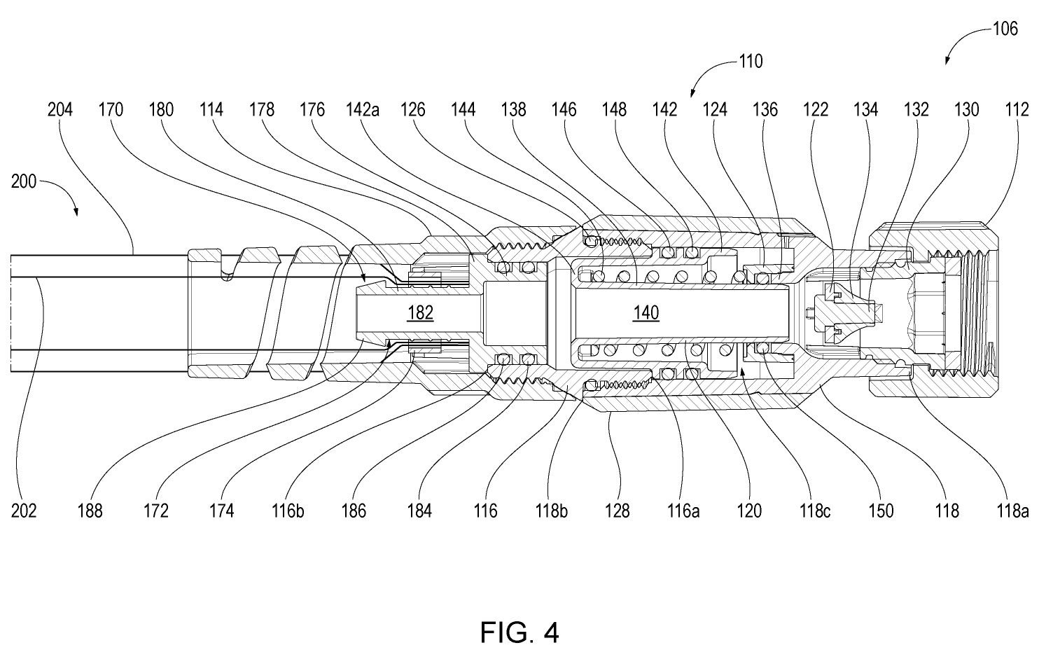

Referring additionally to FIGS. 3-4, the first connector assembly 106 will be described in detail. As shown, the first connector assembly 106 includes a regulator assembly 110, a spigot connector 112 attached to one end of the regulator assembly 110, and a strain relief sleeve 114 that, along with the hose assembly 200, is attached to the other end of the regulator assembly 110.

The regulator assembly 110 is provided to reduce a pressure of fluid flowing through the expandable hose 100. For example, fluid pressure in a spigot may be as high as 140 pounds per square inch (“PSI”), but such high pressure tends to cause traditional hoses to burst and is unnecessary for the operation of lawn and garden accessories like nozzles and sprinklers. The regulator assembly 110 is provided to reduce the pressure of the fluid entering the expandable hose 100 from the spigot to a predetermined pressure. For example, said predetermined pressure may be between 60-80 PSI, and preferably 70 PSI in one embodiment, to prevent the water pressure from causing the expandable hose 100 to burst or become damaged.

With specific reference to FIG. 4, the regulator assembly 110 includes a first housing 116, a second housing 118, a valve stem 120, a valve seat 122, and a spring seat 124. As shown, the first housing 116 extends between opposite, first and second ends 116a, 116b with a passage extending therebetween. More particularly, the first end 116a is provided with an attachment mechanism for attaching to a corresponding end of the second housing 118 (e.g., a threaded connection as shown, a press fit, adhesive, etc.). Further, the second end 116b is likewise provided with an attachment mechanism for attaching to the strain relief sleeve 114 (e.g., a threaded connection as shown, a press fit, adhesive, etc.)

The second housing 118 similarly has opposite first and second ends 118a, 118b with a passage 118c extending therebetween. As shown, the first end 118a of the second housing 118 connects to the spigot connector 112 and the second end 118b is connected to first end 116a of the first housing 116 and sealed thereagainst in a suitable manner, such as by a suitable seal (e.g., an O-ring 126). The second housing 118 can be at least partially surrounded by an overmold 128 or the like.

The first end 118a of the second housing 118 connects to the spigot connector 112 in a suitable manner, such as by an intervening member 130 received in the spigot connector 112 and attached to the first end 118a by a suitable weld, adhesive, threaded connection, press fit, etc. The intervening member 130 may be coupled to the valve seat 122 in a suitable manner, such as by a fastener 132 received in a corresponding opening in a base 134 of the intervening member 130 and that abuts an inner ledge of the base 134 and is held there by a snap connection and/or a suitable weld. The intervening member 130 has a passage with a plurality of circumferentially spaced flow dividers forming one or more (discrete) passages through which the fluid flows from the spigot. The second housing 118 also includes a portion 136 that extends in the passage 118c (e.g., in a direction toward the second end 118b) to surround a body 138 of the valve stem 120. The portion 136 of the second housing 118 is attached to the spring seat 124 in a suitable manner (e.g., welding, adhesive, etc.).

As shown, the body 138 of the valve stem 120 is a hollow member, defining a passage 140 extending therethrough. The body 138 further includes a flanged portion 142 projecting (radially) outward from the body 138. A first side 142a of the flanged portion 142 serves as a spring seat (i.e., opposite the spring seat 124) for a spring 144 (discussed further below). The flanged portion 142 also includes an annular outwardly extending portion defining a ledge that abuts the first end 116a of the first housing 116 in an open position. The outwardly extending portion includes one or more seal grooves for receiving a corresponding seal, such as O-rings 146, 148, which move with the valve stem 120 to maintain a seal between the valve stem 120 and the second housing 118. The valve stem 120 is biased in the open position by the spring 144 and movable against the biasing force by fluid pressure to adjust flow through regulator assembly 110 to a closed position. The spring seat 124 serves as a seat for the other end of the spring 144. The valve stem 120 moves within and is sealed against the spring seat 124 by a suitable seal, such as O-ring 150.

The valve seat 122 includes a seat on a side thereof (i.e., a side facing the valve stem 120) that is contacted by the valve stem 120 in a closed position to block fluid flow through the regulator assembly 110, for example when a high back pressure urges the valve stem 120 in the closed position. When the pressure reduces, the biasing force of the spring 144 will move the valve stem 120 away from the valve seat 122. Accordingly, the valve stem 120 is movable between the open and closed positions to adjust the fluid flow through the regulator assembly 110 based on the pressure of the fluid passing therethrough.

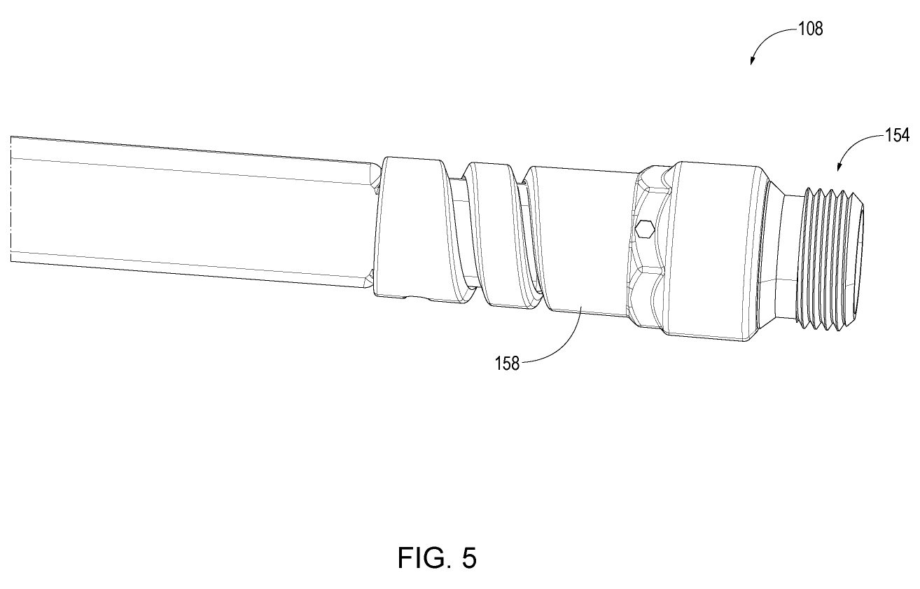

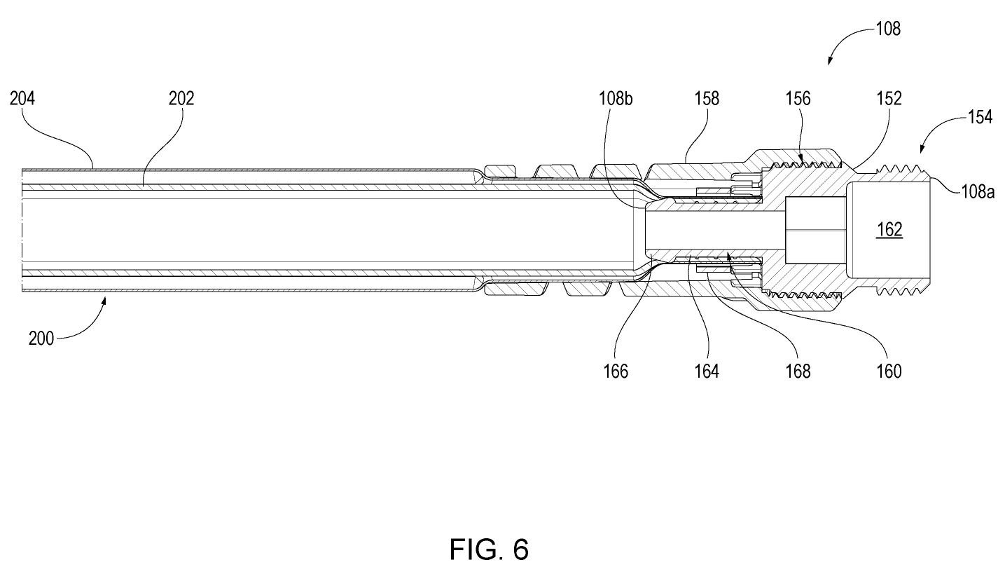

Moving on to FIGS. 5-6, the second connector assembly 108 will now be described in detail. The second connector assembly 108 includes a body 152 with opposite, first and second connection areas 154, 156. The first connection area 154 is configured to connect to a nozzle, sprinkler, etc., for example by a threaded connection. Separately, the second connection area 156 is connected to a strain relief sleeve 158 in a suitable manner (e.g., a threaded connection). The second connector assembly 108 also includes a tube connector 160 extending from the body 152 for connecting to the hose assembly 200. More particularly, the second connector assembly 108 extends between first and second ends 108a, 108b with a passage 162 extending therebetween. In the depicted embodiment, the first end 108a of the second connector assembly 108 is defined by an end of the first connection area 154 and the second end 108b is defined by an end of the tube connector 160. Of note, the body 152 and the tube connector 160 are integrally formed.

As further shown in FIG. 6, the hose assembly 200 includes an inner tube 202 and an outer tube 204, wherein the latter surrounds and covers the former. Notably, the outer tube 204 is exposed to an ambient environment. In other words, a portion of the outer tube 204 (i.e., the portion extending between the first and second connector assemblies 106, 108) defines an outer surface of the expandable hose 100. Moreover, in the depicted embodiment, the inner tube 202 is disposed within the outer tube 204 without any intervening members being provided therebetween. As shown, the tube connector 160 receives the corresponding (second) ends of the inner and outer tubes 202, 204, respectively, and includes an elongate portion 164 with a bulbous or radiused end 166 over which the corresponding ends of the inner and outer tubes 202, 204 are received to prevent rupture/tearing of the tubes when bent. As further shown, a retainer 168 (e.g., a clamp, a ring, etc.) secures the corresponding ends of the inner and outer tubes 202, 204 on the elongate portion 164. More specifically, the retainer 168 secures the inner and outer tubes 202, 204 on the elongate portion 164 of the tube connector 160 such that an inner surface of the inner tube 202 directly faces and contacts an outer surface of the elongate portion 164 (e.g., without any intervening members disposed therebetween), and such that an inner surface of the outer tube 204 directly faces and contacts an outer surface of the inner tube 202 (again without any intervening members disposed therebetween). Further, an inner surface of the retainer 168 directly faces and contacts an outer surface of the outer tube 204. This arrangement permits a slim design wherein the interconnection between the inner and outer tubes 202, 204 and the tube connector 160 does not take up a large footprint (e.g., in a radial or lateral direction) within the second connector assembly 108.

Of note, the first connector assembly 106 includes a similar connection mechanism for coupling with corresponding (first) ends of the inner and outer tubes 202, 204. More specifically, with reference again to FIG. 4, the hose assembly 200 further includes a first hose connector assembly 170 having a tube connector 172 and a retainer 174. The tube connector 172 includes a base 176 having a flanged portion 178, an elongate portion 180 extending from the base 176 that has one or more ribs for gripping the inner tube 202, and a passage 182 extending through the base 176 and elongate portion 180. The base 176 is disposed within the second end 116b of the first housing 116 and sealed thereto by one or more suitable seals, such as O-rings 184, 186, and the flanged portion 178 is held between the second end 116b of the first housing 116 and an inner surface of the strain relief sleeve 114 to couple the tube connector 172 to the first connector assembly 106. The elongate portion 180 receives corresponding ends of the inner and outer tubes 202, 204 and includes a bulbous or radiused end 188 over which the ends of the inner and outer tubes 202, 204 are received, providing a rounded area to prevent rupture/tearing of the inner and outer tubes 202, 204 when bent. Each corresponding end of the inner and outer tubes 202, 204 is held on the elongate portion 180 by the retainer 174, which may be a suitable clamp or the like and may be connected thereto in a similar manner as described above with respect to the tube connector 160 of the second connector assembly 108.

The inner tube 202 of the hose assembly 200 may be made of a suitable material that expands radially or laterally but has substantially no expansion longitudinally when a pressurized fluid is introduced into the inner tube 202. For example, in one embodiment, the inner tube 202 may be constructed from a thermoplastic elastomer that is free of bisphenol A (BPA) and phthalates. The outer tube 204 of the hose assembly 200 may be made of a suitable material, such as a synthetic fiber, such as polyester or nylon, which is woven and stitched on its sides. Notably, the inner and outer tubes 202, 204 are substantially flat in the absence of a pressurized fluid to reduce the footprint of the hose assembly 200 for storage, carry, and the like.

Accordingly, owing to the material construction of the inner tube 202, the hose assembly 200 is arrangeable in different, first and second configurations depending on an operable state thereof. More specifically, in the first configuration (i.e., where no pressurized fluid is supplied to an inner passage of the inner tube 202), the hose assembly 200 is maintained in a relatively flat arrangement such that the inner tube 202 has a first longitudinal dimension (i.e., a length between corresponding ends of the inner tube 202 extending in a longitudinal or axial direction thereof) and a first lateral dimension (i.e., a width between corresponding sides of the inner tube 202 extending in a direction perpendicular to a central axis thereof). By applying pressurized fluid to the inner passage of the inner tube 202, the hose assembly 200 transitions to its second (operable) configuration, where the inner tube 202 expands radially (i.e., laterally) to a second lateral dimension which is greater than the first lateral dimension. With this said, because of the material construction of the inner tube 202, the inner tube 202 is maintained at the first longitudinal dimension even in the second state. Accordingly, it is to be understood that the hose assembly 200 (e.g., the inner tube 202 alone or the inner and outer tubes 202, 204 in combination) does not longitudinally expand when subjected to pressurized fluid.

As briefly mentioned above, the first connector assembly 106 may be coupled directly to the spigot or may be coupled thereto via an intervening member. For example, a male fitting of a fluid quick connector may be coupled (e.g., threaded onto) the spigot, and a corresponding female fitting of the fluid quick connector may be coupled (e.g., threaded) to the spigot connector 112. The same may be true for the second connector assembly 108, wherein a male fitting of a fluid quick connector is coupled (e.g., threaded onto or otherwise attached) to the water delivery device or vehicle, and a female fitting of the fluid quick connector is coupled (e.g., threaded) on the first connection area 154 of the body 152.

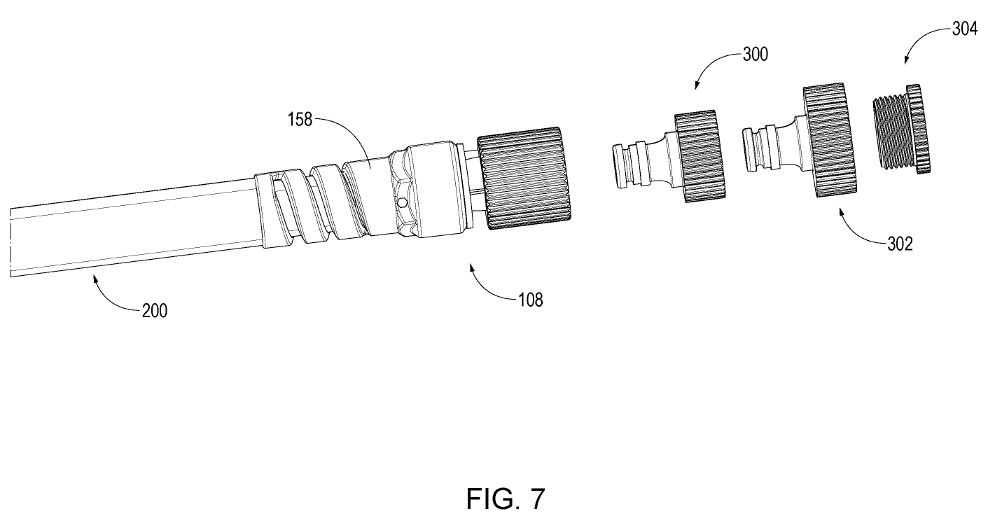

Yet in other embodiments, a female fitting of a quick connector may be integrated into the second connector assembly 108. For example, with reference to FIGS. 7-9, a separate embodiment of the second connector assembly 108 is shown. Notably, similar (or the same) reference numerals will be used to designate like parts for simplicity.

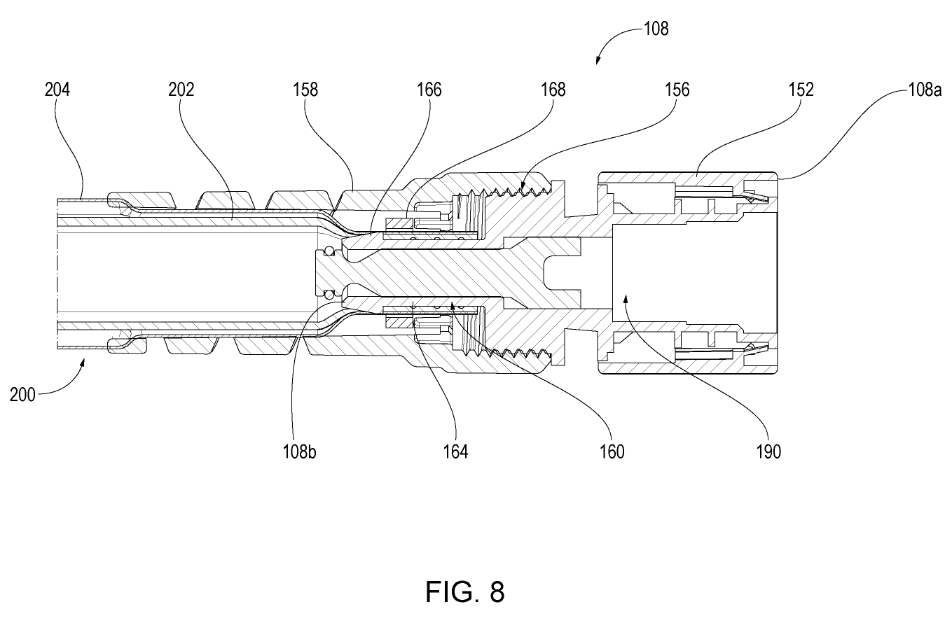

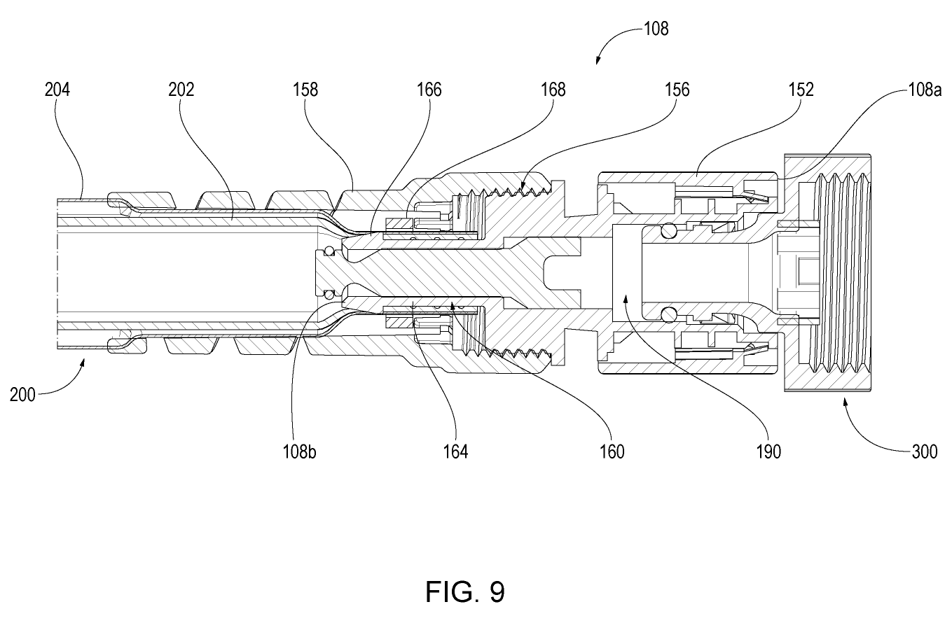

As shown in FIG. 8, the body 152 again includes a connection area 156 for connecting with the strain relief sleeve 158 in a suitable manner (e.g., a threaded connection). However, rather than having a second or additional connection area (e.g., connection area 154 as shown in FIG. 6), the body 152 here includes an integral female fitting of a fluid quick connector, defining a central bore 190 for receiving an end of a corresponding male fitting (e.g., as shown in FIG. 9).

With quick reference to FIG. 7, the corresponding male fitting may be either a first male fitting 300 or a second male fitting 302. The first male fitting 300 is configured to be coupled to a spigot having a BSP thread size of (for example) 1”, whereas the second male fitting 302 is configured to be coupled to a spigot having a BSP thread size of (for example) 0.75”. In the situation where a user has a spigot size of (for example) 0.5”, an adapter 304 may be connected directly to the spigot to provide a connection point having a BSP thread size of 0.75”, thereby permitting the second male fitting 302 to connect thereto. Indeed, either the first or second male fitting 300, 302 may connect/disconnect to the body 152 in a known and conventional manner.

Moving back to FIG. 8, the body 152 again is integrally formed with the tube connector 160 that receives corresponding ends of the inner and outer tubes 202, 204. Similar to the embodiment depicted in FIG. 6, the inner and outer tubes 202, 204 here are secured to and held against the tube connector 160 via the retainer 168 in the same manner described above.

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A hose comprising:
a first connector assembly including a regulator assembly configured to regulate a flow of fluid through the hose to reduce a pressure of the fluid;
a second connector assembly; and
a hose assembly coupled to the first and second connector assemblies, the hose assembly comprising:
an outer hose member having first and second ends;
an inner hose member having first and second ends, the inner hose member being disposed within the outer hose member; and
a first hose connector assembly coupled to the first ends of the inner hose member and the outer hose member, and the first connector assembly, the first hose connector assembly including a first tube connector having a base disposed in a body of the regulator assembly and an elongate portion extending from the base,
wherein an inner surface of the inner hose member at the first end thereof contacts an outer surface of the elongate portion, and wherein an inner surface of the outer hose member at the first end thereof contacts an outer surface of the inner hose member at the first end thereof.

2. The hose of claim 1, wherein the first hose connector assembly further includes a retainer surrounding the elongate portion.

3. The hose of claim 2, wherein an inner surface of the retainer contacts an outer surface of the outer hose member at the first end thereof.

4. The hose of claim 1, wherein the outer hose member is exposed to an ambient environment.

5. The hose of claim 1, wherein the elongate portion has a bulbous end opposite from the base, and wherein the first end of the inner hose member is received over the bulbous end.

6. The hose of claim 1, wherein the hose is arrangeable in first and second configurations, wherein in the first configuration, the hose assembly has a first longitudinal length and a first lateral width, wherein in the second configuration, the hose assembly has a second lateral width greater than the first lateral width, and wherein the hose assembly maintains the first longitudinal length in the second configuration.

7. The hose of claim 6, wherein the hose is configured to transition from the first configuration to the second configuration when the fluid enters a passage of the inner hose member.

8. The hose of claim 1, wherein the hose does not longitudinally expand when subjected to the fluid.

9. The hose of claim 1, wherein the hose assembly further includes a second hose connector assembly coupled to the second ends of the inner hose member and the outer hose member, and the second connector assembly, the second hose connector assembly including a second tube connector.

10. The hose of claim 9, wherein the inner surface of the inner hose member at the second end thereof contacts an outer surface of the second tube connector, wherein the inner surface of the outer hose member at the second end thereof contacts the outer surface of the inner hose member at the second end thereof.

11. The hose of claim 10, wherein the second hose connector assembly further includes a retainer surrounding the second tube connector.

12. The hose of claim 11, wherein an inner surface of the retainer contacts an outer surface of the outer hose member at the second end thereof.

13. The hose of claim 12, wherein the second tube connector includes a base with an elongate portion extending therefrom, wherein the elongate portion of the second tube connector has a bulbous end, and wherein the second end of the inner hose member is received over the bulbous end of the second tube connector.

14. The hose of claim 1, wherein the regulator assembly includes a valve stem disposed in the body, and a valve seat disposed in the body, wherein the valve stem is biased in an open position and movable to a closed position against the valve seat, and wherein fluid flow through the regulator assembly is blocked when the valve stem is in the closed position.

15. The hose of claim 1, wherein the first connector assembly includes a fluid connector upstream of and coupled to the regulator assembly, and wherein the fluid connector is configured to be fluidly coupled to a spigot.

16. The hose of claim 15, wherein the fluid connector is configured to be directly coupled to the spigot.

17. A hose comprising:
a first connector assembly including a regulator assembly configured to regulate a flow of fluid through the hose to reduce a pressure of the fluid;
a second connector assembly; and
a hose assembly coupled to the first and second connector assemblies, the hose assembly comprising:
an outer hose member having first and second ends, the outer hose member being exposed to an ambient environment;
an inner hose member having first and second ends, the inner hose member being disposed within the outer hose member; and
a first hose connector assembly coupled to the first ends of the inner hose member and the outer hose member, and the first connector assembly, the first hose connector assembly including a first tube connector and a first retainer, wherein the first tube connector has a base disposed in a body of the regulator assembly and an elongate portion extending from the base, and wherein the first retainer surrounds the elongate portion,
wherein an inner surface of the inner hose member at the first end thereof contacts an outer surface of the elongate portion, wherein an inner surface of the outer hose member at the first end thereof contacts an outer surface of the inner hose member at the first end thereof, and wherein an inner surface of the first retainer contacts an outer surface of the outer hose member at the first end thereof, and
wherein the hose does not longitudinally expand when subjected to the fluid.

18. The hose of claim 17, wherein the hose assembly further includes a second hose connector assembly coupled to the second ends of the inner hose member and the outer hose member, and the second connector assembly, the second hose connector assembly including a second tube connector and a second retainer,
wherein the inner surface of the inner hose member at the second end thereof contacts an outer surface of the second tube connector, wherein the inner surface of the outer hose member at the second end thereof contacts the outer surface of the inner hose member at the second end thereof, and wherein an inner surface of the second retainer contacts the outer surface of the outer hose member at the second end thereof.

19. The hose of claim 18, wherein the regulator assembly includes a valve stem disposed in the body, and a valve seat disposed in the body, wherein the valve stem is biased in an open position and movable to a closed position against the valve seat, and wherein fluid flow through the regulator assembly is blocked when the valve stem is in the closed position.

20. The hose of claim 19, wherein the first connector assembly includes a fluid connector upstream of and coupled to the regulator assembly, and wherein the fluid connector is configured to be fluidly coupled to a spigot.
